(19) United States
(12) Patent Application Publication
(10) Pub. No.: US 2013/0232014 A1
(43) Pub. Date: Sep. 5, 2013

(54) SYSTEMS AND METHODS FOR IMPROVING BUSINESS VISIBILITY ON INTERNET SEARCH ENGINE RESULTS PAGES

(71) Applicants: Rodney Layton Judd, Chapel Hill, NC (US); Kristen Wohadlo Judd, Chapel Hill, NC (US); Leonard Raymond Wohadlo, Chapel Hill, NC (US)

(72) Inventors: Rodney Layton Judd, Chapel Hill, NC (US); Kristen Wohadlo Judd, Chapel Hill, NC (US); Leonard Raymond Wohadlo, Chapel Hill, NC (US)

(73) Assignee: FIREFLY MEDIA, LLC, Chapel Hill, NC (US)

(21) Appl. No.: 13/599,384

(22) Filed: Aug. 30, 2012

Related U.S. Application Data
(60) Provisional application No. 61/530,639, filed on Sep. 2, 2011.

(51) Int. Cl. G06Q 30/02

(52) U.S. Cl. CPC G06Q 30/0277
USPC 705/14.73

(57) ABSTRACT

Computerized systems and methods for marketing a business or company on the Internet and for optimizing and improving the business's or company's visibility on search results pages of conventional Internet search engines. The system and method including modules configured to allow the business or company to create an Engagement Site, create and send electronic communications to customers and prospective customers, and publish and store electronic communications on the Engagement Site.

### CROSS REFERENCES TO RELATED APPLICATIONS

This application claims the benefit of U.S. Provisional Patent Application Ser. No. 61/530,639, filed on Sep. 2, 2011, the contents of which are incorporated herein by reference in their entirety.

### FIELD

The present disclosure relates generally to computerized systems and methods for marketing companies on the Internet.

### BACKGROUND

Businesses market themselves or engage marketing agencies to market their business and products and services of their business on the Internet and the World Wide Web, through a variety of channels, which can include marketing on or through the use of primary websites, secondary websites, microsites, mobile websites, email campaigns, email newsletters, blogs, content marketing, banner advertisements, pay-per-click advertising, social media, text messaging, and other digital channels. At the most basic level, the objectives of these digital marketing initiatives are to retain existing customers, attract new prospective customers, and increase brand awareness associated with the business.

As more and more consumers conduct business, shop, search for specific businesses, and search for specific goods and services on the Internet, it is becoming even more critical for businesses and their specific products and services to be readily, easily, and more frequently “found” on the Internet. Simply stated, this means that when a consumer is using a conventional Internet search engine, such as Google®, Yahoo®, or Bing®, to search for a specific business, type of business, product, or service provider, businesses that fit the search term criteria entered by the consumer want to come up, as many times as possible, on Search Engine Results Pages (“SERPs”).

Most conventional Internet search engines use their own complex, proprietary algorithms, and use web crawlers or web spiders to search the Internet, index, and rank websites or webpages in a manner that determines where different websites or webpages will be ordered, positioned, or located (and hence the order in which the websites or webpages will appear) on SERPs in response to different key word searches. When a search engine web crawler browses or crawls a website or webpage and finds new content on the site, that website or webpage will typically rank higher in SERPs than a competitor's site that has not been refreshed with new content since the last time such website or webpage was crawled.

Statistics demonstrate that most Internet users, which include consumers, prefer “organic” search results, which are the ranked search results that generally appear in the main body of the search engine results webpage, as opposed to paid search results, which are highlighted and often placed at the top or at one of the sides of the search results webpage, but which are obviously “advertisements” and not merely the search engine's ranked search results. Statistics also demonstrate that most Internet users scan and review, at most, the search results that appear one the first two pages of the ranked search results. Rarely do consumers go, or need to go beyond the second page of the search results to find the page they are looking for or a page that sufficiently satisfies their search criteria.

### SUMMARY

In general, systems and methods are disclosed herein that include improved computer-implemented processes, techniques, and technologies that take advantage of the searching and ranking algorithms and procedures used by the conventional Internet search engines to improve the marketing results for businesses by enhancing and increasing the visibility of such businesses on the organic search results pages.

Most conventional Internet search engines typically present ten (10) organic search results per page, and as mentioned above, most Internet users generally review the first two pages of the search results. Thus, it is advantageous for a business to appear on the first page or second page of the organic search results. It is even more advantageous for the business to appear more than once, as a separate search result entry, on the first page and/or second page of the search results. The more times a business appears on the first page or second page of a search results page, the higher the likelihood that traffic and, by extension, leads that will be delivered to the business, as opposed to its competition. In other words, businesses have a strong business and marketing incentive to dominate the first page and/or the second page of the SERPs for searches relevant to their business name, business type, business brands, and for their relevant products and/or services.

In an embodiment, a system and method for increasing visibility of a business on Internet search engines includes an email module configured to create an electronic communication from a client to a customer or prospective customer of the client, send the electronic communication to the customer or prospective customer of the client, and publish the electronic communication on an Engagement Website of the client having a domain name different from a main website of the client, The electronic communication published on the Engagement Website may also be cached to allow Internet search engines to index the electronic communication.

A website module may create the Engagement Website, and the electronic communication may include a hyperlink to the Engagement Website. Further, a social media module may create social media for the client and publishing the social media content on a social media website of the client. The social media module may also monitor social media websites for comments about the client and provide suggestions to the client for responses to the comments.

Additional features and aspects of the systems and methods disclosed herein are apparent from the following detailed description and drawings.

### BRIEF DESCRIPTION OF THE DRAWINGS

Embodiments of the systems and methods disclosed herein are illustrated in the figures of the accompanying drawings which are meant to be exemplary and not limiting, in which like references are intended to refer to like or corresponding parts, and in which:

FIG. 1 illustrates a multi-client flow diagram of the system and method;

FIG. 2 illustrates a first embodiment of a single client flow diagram of the system and method; and

FIG. 3 illustrates a second embodiment of a single client flow diagram of the system and method.

### DETAILED DESCRIPTION

Detailed embodiments of systems and methods are disclosed herein, however, it is to be understood that the disclosed embodiments are merely exemplary of the systems and methods, which may be embodied in various forms. Therefore, specific functional details disclosed herein are not to be interpreted as limiting, but merely as a basis for the claims and as a representative basis for teaching one skilled in the art to variously employ the systems and methods disclosed herein.

The systems and methods relate generally to computerized systems and methods for marketing businesses and companies on the Internet and, more particularly, to improved systems and methods for optimizing and improving a business's or company's visibility on search results pages of conventional Internet search engines, such as Google®, Yahoo®, or Bing®.

At a fundamental level, there are a number of basic ingredients that help maximize the number of times a particular business actually appears on page one (1) and/or page two (2) of a typical organic search results page, for example, including but not limited to: (1) maintaining a presence on the Internet across a number of different websites or webpages; and (2) consistently generating fresh or new content on such different websites or webpages.

The systems and methods disclosed herein, include improved computer-implemented processes, techniques, and technologies that take advantage of the searching and ranking algorithms and procedures used by the conventional Internet search engines to improve the marketing results for businesses by enhancing and increasing the visibility of such businesses on the organic search results pages. The systems and methods are designed to deliver a two-pronged benefit to businesses, including: (1) fostering customer or consumer retention and acquisition (2) while augmenting the presence of the business on the Internet and search engine visibility.

Generally, the systems and methods disclosed herein include and are implemented within a computer system, network of computer systems, or one or more mobile devices, having one or more databases and other storage apparatuses, servers, computer networks, and additional components, for example, processors, modems, terminals and displays, computer-readable media, algorithms, modules, and other computer-related components. The computer systems and/or computing infrastructure are especially configured, programmed, and adapted to perform the functions and processes of the systems and methods as disclosed herein.

Communications between components in the systems and methods disclosed herein may be unidirectional or bidirectional electronic communication through a wired or wireless configuration or network. For example, one component may be wired or networked directly, indirectly, through a third party intermediary, wirelessly, over the Internet, or otherwise with another component to enable communication between the components.

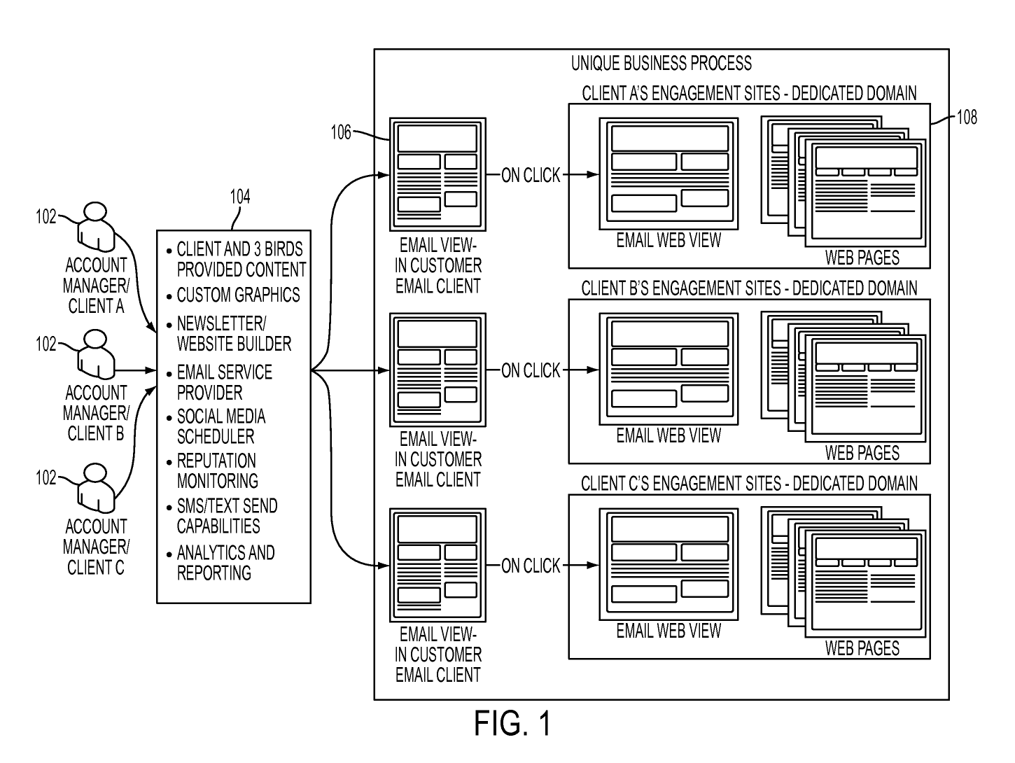

The systems and methods include a computerized marketing system including one or more processors configured to provide a user interface and enable a business to create, distribute, manage, and monitor its electronic marketing solutions and initiatives. A multi-client flow diagram according to an illustrative embodiment is described with reference to FIG. 1. As illustrated in FIG. 1, multiple marketing account managers 102 or clients (the “Users”), which may be businesses, may access the computerized marketing system 104 via a user interface accessible by a client device, for example, a computer, a tablet computer, a smart phone, a personal digital assistant (PDA), and other devices that can access, provide, transmit, receive, and modify information over wired or wireless networks.

In an illustrative embodiment, the user interface is, for example, an interface accessible by the client device, an application, and/or a remotely accessible interface. The user interface may include visual, audio, graphics, charts, and other features of the type. The user interface may include one or more menus incorporating a number of specific questions, prompts, selection boxes, fillable fields, or any combination thereof that the user or client may answer, select, or input data into, for example, by typed, stylus/touch-screen, oral, and/or written.

The computerized marketing system 104 and user interface allows the client 102 to access client and third party provided content, custom graphics, a newsletter/website builder, an email builder, a social media monitoring system or scheduler, a reputation monitoring module, a text scheduler, and data silos, data engine, and data analysis tools, including analytics and reporting tools. The computerized marketing system 104 and user interface allows the client 102 to build and send out one or more email newsletters to the business's or client's customers and prospective customers. In other embodiments, other types of electronic communications, such as email campaigns, blog posts, alerts, mobile notifications, publications, news releases, announcements, invitations, and other electronic communications that may be initiated by the business or client 102 and sent out to one or more of the business's or client's customers or prospective customers by the computerized marketing system 104. For ease of reference, such communications are referred to herein as an “electronic communication” 106.

The computerized marketing system 104 may be configured to cache or publish the electronic communication(s) 106 into or onto a fully functional website or webpage on a client's or business's own dedicated domain (referred to herein as an “Engagement Site” 108), which complements but may have a different, but still a business-branded, domain name than the domain name used for the business's main website or webpage. Conventionally, whenever a business or company issues a newsletter, email alert, email campaign, or other electronic article or press release, the electronic communication is placed on a subpage or webpage that branches off of the business's main website or webpage (for example, www.businessname.com/article.html), or the electronic communication is delivered or distributed by a third party and merely refers back to a landing site hosted and provided by a third party mass communication company (for example, www.emailserviceprovider.com/businessname/month_year_newsletter.html or other similar website or webpage). Having the electronic communication hosted and linked back to the third party service provider's website or webpage provides minimal, ancillary benefit to the business with regard to search engine optimization results. Having the electronic communication appear as a subpage off of the business's main website or webpage is better, but still does not do much or enough to enhance the business significantly, from the search engine perspective.

For these reasons, the computerized marketing system 104 and methods disclosed herein publish the business's electronic communication(s) 106 on or to the Engagement Site 108 where the electronic communication(s) 106 is cached and archived; thereby, refreshing the Engagement Site 108 with a consistent infusion of fresh content that can then be indexed by search engines. In some embodiments, the computerized marketing system 104 publishes or cross-links the electronic communication(s) 106 between the main business website or webpage of the client 102 or business and the Engagement Site 108. In an illustrative embodiment, a domain structure may be used advantageously in the computerized marketing system 104 and methods disclosed herein. For example, if the domain for the main website or webpage of the business is www.yourbusiness.com, a different, dedicated domain for the Engagement Site 108 where electronic communications 106 to customers or consumers are published and archived could be www.yourbusinessnews.com or something similar. It is beneficial, whenever possible, for the Engagement Site domain name to include or embed the business name, for example, “yourbusiness”, within the larger domain name string or embed one or more of the major brand names associated with the business, or some combination thereof.

The combination of a dedicated Engagement Site domain, a complementary domain structure with the main website or webpage and the consistent supply of new quality content related to the business and the products and/or services offered by the business, results in organic search results for the business that rank higher in SERPs and provide greater visibility for the business than if email newsletters, email campaigns, or other electronic communications with clients are published and/or archived on a webpage that branches off of the domain name of the business's website or webpage, or that branches off of the domain name of the third party service provider of the email or other electronic communication.

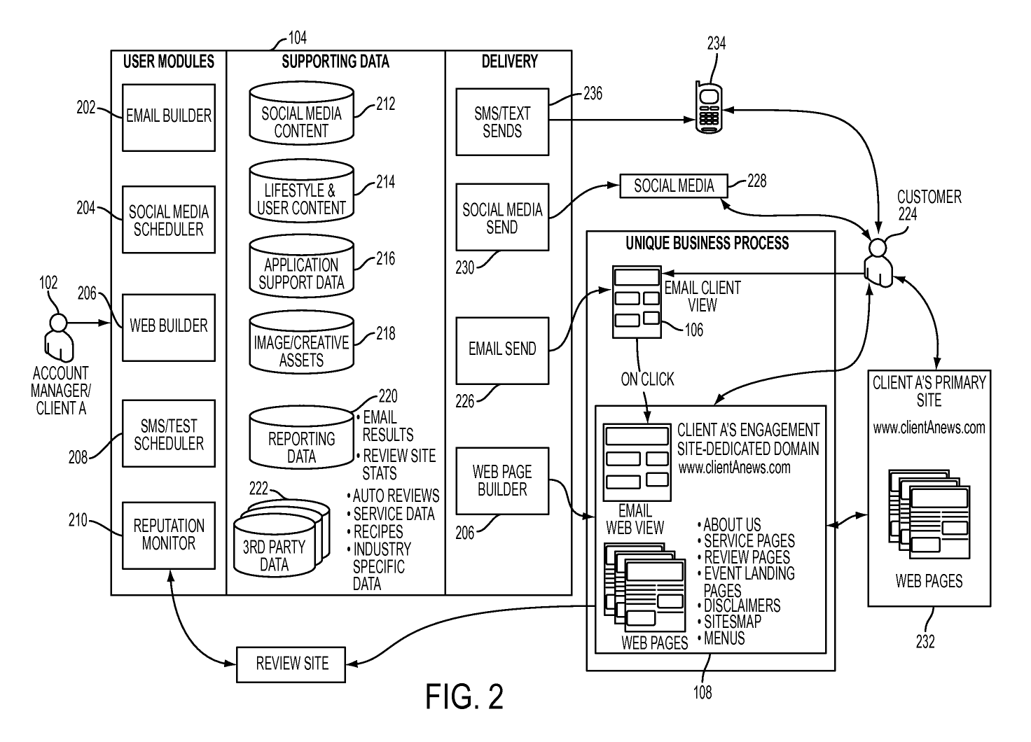

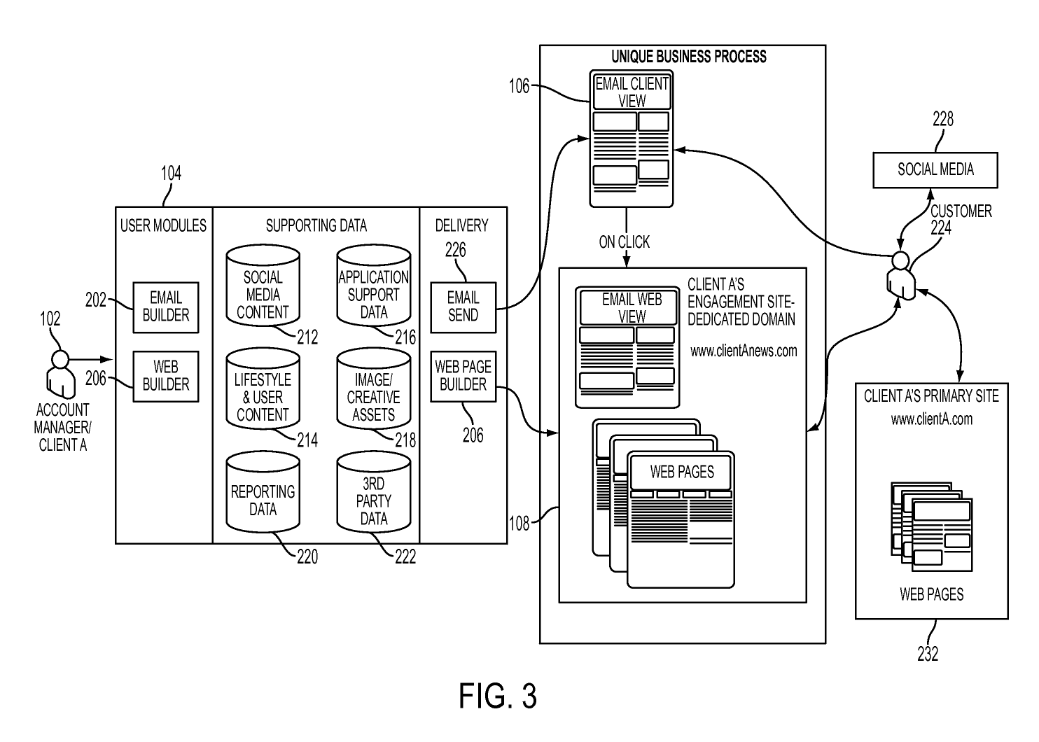

Single client flow diagrams according to illustrative embodiments are described with reference to FIGS. 2 and 3. As illustrated in FIG. 2, the computerized marketing system 104 includes one or more modules accessible by the client 102, including an email builder module 202, a social media scheduler module 204, a web builder module 206, a Short Message Service (SMS)/Text scheduler module 208, and a reputation monitor module 210, to the client 102 to deliver and monitor electronic marketing communications. The computerized marketing system 104 also includes one or more databases accessible by the modules 202-210 and the client 102, including a social media content database 212, a lifestyle and user content database 214, application support data 216, an images/creative assets database 218, reporting data 220, and third party data 222. While the various databases 212-222 are illustrated as separate and distinct databases, the various databases 212-222 can be combined into one or more databases.

Referring to FIGS. 2 and 3, in an illustrative embodiment, the client 102 can access the email builder module 202 of the computerized marketing system 104 via the user interface to create electronic communications 106, for example, email messages and newsletters, to be sent to one or more customers or consumers 224 of the client 102 by an email delivery module 226, which may be part of or separate from the email builder module 202. The email builder module 202 may provide the client 102 with access to the various databases 212-222 containing various types of content that can be incorporated into the electronic communications 106. The email builder module 202 may also provide the client 102 with one or more templates for creating emails and newsletters.

Email newsletters can be a valuable tool for maintaining and strengthening relationships with customers 224 and prospective customers, but the competition for email users' attention is fierce. Research has demonstrated that email users spend approximately 51 seconds reading the average email newsletter, yet 69% of email users reported that they “look forward” to receiving at least one e-newsletter. In an illustrative embodiment, the email builder module 202 can prepare and send an email newsletter from the client or business 102 to customer email subscribers, for example customers 224. The content that can be incorporated into the email newsletter from the various databases 212-222 may include, for example, in relation to a car dealership client, relevant, engaging content such as: vehicle reviews, new model information, buying guides, service and maintenance tips, and “lifestyle” and “how-to” articles. The email builder module 202 can include exclusive sales specials, service coupons and other content specific to the business or car dealership, in this example, into the email newsletter. The email builder module can be used to construct each issue of the email newsletter to convey an overall theme and marketing message for the month through inclusion of articles, coupons and other features stored, for example, in the various databases 212-222.

The email builder module 202 may incorporate hyperlinks into the email newsletters to drive traffic to the websites or webpages of the client 102. The email builder module 202 may incorporate video content such as video reviews or other video content created by the client 102 into the email newsletters. The email builder module 202 may incorporate social sharing buttons into the email newsletters to enable readers to easily share any coupon, specials or article to their social networks and buttons that navigate to social media websites of the client 102. These social sharing tools can increase the reach of email offers and extend awareness of the client 102 or business across the Internet. The email builder module 202 may also incorporate third party data, for example, articles and other content published or written by third parties that is relevant to the business of the client 102 into the email newsletters.

The email builder module 202 may track and report on deliverability, open rates, click through rates, click tracking and the effectiveness or performance of the email newsletter. The email builder module 202 may compile this data and store the data, for example in the reporting data 220, to obtain the behavioral history of the customers 224 for future segmentation and targeted marketing. The email builder module 202 may segment the customers 224 into one or more subgroups and target email newsletters to the specific subgroups or all of the subgroups as a whole.

Referring to FIG. 2, in an illustrative embodiment, the client 102 can access the social media scheduler module 204 of the computerized marketing system 104 via the user interface to create electronic communications 106, for example, social media messages, updates, and posts, to be published on a social media website 228 of the client 102 by a social media delivery module 230, which may be part of or separate from the social media scheduler module 204. Similar to the email builder 202 described above, the social media scheduler module 204 may provide the client 102 with access to the various databases 212-222, including the social media content database 212, containing various types of content that can be incorporated into the electronic communications 106, provide the client 102 with one or more templates for creating social media content, and prepare and send social media content to the social media website 228 of the client 102.

In an illustrative embodiment, the social media scheduler module 204 extends the client's business online marketing and communication efforts into the arena of social media. The social media scheduler module 204 provides tools and services for establishing and consistently managing the social media presence of the client 102 and for continuously monitoring and protecting the reputation of the client 102 online.

In general, social media websites can include Facebook, Twitter, YouTube, Flickr, LinkedIn, Foursquare and other similar websites. Facebook alone has more than 400 million registered users worldwide and at least about 34.6% of the adult population in the United States is using Facebook. Recent research established that the average Facebook user spends about 6 hours and 43 minutes on Facebook every month. Of course, there is more to social media than Facebook, but one thing is clear, customers 224 are online and they are communicating. Not only are customers 224 spending time on social media sites, the customers 224 expect the client 102 to have a presence. In general, about 93% of social media users expect the companies and businesses they buy from to have a presence in social networks.

In an illustrative embodiment, the social media scheduler module 204 monitors social media sites, blogs and review sites for comments about the client 102 and provides suggestions for appropriate responses to online comments, as necessary. The data obtained from monitoring the media sites, blogs and review sites may be stored, for example, in the reporting data 220 and/or the lifestyle and user content database 214. This allows the client 102 to have an orchestrated plan each month for publishing the correct balance of content across email, social media sites and the website of the client 102 to accomplish marketing objectives. The social media scheduler module 204 increases efficiencies, which enable the client 102 to have meaningful engagement and interaction with customers 224 and maintain a positive reputation. In an illustrative embodiment, the social media scheduler module 204 monitors online mentions of the client 102 which provides valuable information about the performance of each department from a customer's perspective and enables the client 102 to identify and correct problems and/or procedural gaps. Continuously monitoring and promptly responding to online mentions of the client 102 helps solve problems quickly and demonstrates the client's 102 commitment to customer satisfaction. Transparently solving problems, taking the time to thank and appreciate customers 224 and consistently showing that the client 102 strives to maintain long term relationships with customers 224 can lead to a beneficial customer reputation.

In an illustrative embodiment, the social media scheduler module 204 creates and suggests appropriate responses, to potentially negative comments on social media websites, intended to reflect the commitment of the client 102 to transparency and outstanding customer service. The social media scheduler module 204 can track the reach and influence of content and visitors to the social media website of the client 102. The social media scheduler module 204 may also place email subscription boxes on social media pages of the client 102 to capture additional contact information, leads and to grow an email subscriber list of the client 102.

The social media scheduler module 204 may communicate with other modules in the computerized marketing system 104 and execute a content publishing plan each month designed to promote a consistent message and marketing plan across your email communications, website and social media pages. In an illustrative embodiment, the social media scheduler module 204 can also monitor actions and promotions of direct competitors of the client 102 providing the client 102 with a distinct competitive advantage.

Referring to FIGS. 2 and 3, in an illustrative embodiment, the client 102 can access the web builder module 206 of the computerized marketing system 104 via the user interface. The web builder module 206 creates or provides tools that allow the client 102 to create and customize the Engagement Site 108 which, in addition to caching emails, social media content, and other electronic communications, further establishes the brand of the client 102, increases web traffic to a primary website 232 of the client 102.

In an illustrative embodiment, the web builder module 206 stores each electronic communication 106 on the Engagement Site 108 with a dedicated URL providing a regular source of fresh, informative content. The dedicated URL and steady influx of fresh content expands and increases the likelihood that the client 102 will be identified in organic search engine results of a search engine in response to relevant key words.

In an illustrative embodiment, the web builder module 206 provides a client 102 with a selection of interchangeable profit generating widgets designed to capture sales, service and finance leads. The web builder module 206 may also include a blog on the Engagement Site 108 that makes posting blog entries complete with photos and/or videos virtually foolproof.

Referring to FIG. 2, in an illustrative embodiment, the client 102 can access the Short Message Service (SMS)/Text scheduler module 208 of the computerized marketing system 104 via the user interface to create electronic communications 106, for example, text messages and other messages, to be sent to a mobile device, such as a mobile phone 234, the client 102 by a SMS/Text delivery module 236, which may be part of or separate from the SMS/Text scheduler module 208. Similar to the email builder 202 and the social media scheduler module 204 described above, the SMS/Text scheduler module 208 may provide the client 102 with access to the various databases 212-222 containing various types of content that can be incorporated into the electronic communications 106, provide the client 102 with one or more templates for creating text and other messages, and prepare and send text and other messages to the mobile phone 234 of the client 102.

Referring to FIG. 2, in an illustrative embodiment, the client 102 can access the reputation monitor module 210 of the computerized marketing system 104 via the user interface. The reputation monitor module 210 may monitor electronic websites, social media sites, blogs and review sites for comments about the client 102. The reputation monitor module 210 may also capture and store, for example, in the reporting data 220 and/or the lifestyle and user content database 214, customer behavioral history for future segmentation and targeted marketing campaigns.

In an illustrative embodiment, the computerized marketing system 104 may include a brain module that captures and stores, customer behavioral history for future segmentation and targeted marketing campaigns. The brain module provides fully customized marketing agency services tailored to the specific needs of each individual client 102 delivered through a powerful integrated platform. The brain module analyzes the performance metrics of every marketing initiative taken on behalf of the client 102. Every contact with the customers 224 and prospective customers through a touchpoint of the brain module produces valuable data which is amassed and stored for later use. The brain module sorts, segments, analyzes and uses this data to identify, for example, the best channels for reaching customers and prospective customers, the best times to reach the customers, and the most relevant messages and offers to deliver to the customers, to maximize the impact of and return on the client's marketing investment.

The brain module for each client 102 may function differently. Each brain module for each client 102 has an individual personality relevant to the client 102 with unique demographic attributes to the client's pool of customers and prospective customers and specific marketing objectives. The brain module formulates and executes a well-orchestrated multi-channel marketing plan for the client 102 and regularly refines the plan for peak performance and return on investment. The brain module works to ensure that the offline and online efforts dovetail together and to fine-tune the balance for maximum impact and economy. The detailed customer data that is collected and stored is used to deliver relevant offers and information to targeted groups and subgroups of customers leading to better qualified leads and higher conversion rates. The brain module captures and layers additional fields of customer data on existing customer information every time a customer clicks through on a link in an email, navigates around the client's website or shares or interacts on social media sites.

The brain module provides integrated reporting and analytics to more meaningfully evaluate performance across multiple channels. The brain module facilitates and creates targeted custom email campaigns; custom designed direct mail pieces; complementary direct mail and email campaign pairings; banner ads; multi-channel contest creation, promotion and management; multi-channel promotion creation, implementation and management; SMS and multimedia messaging service (MMS) solutions, campaign creation and integration with other online marketing vehicles; additional websites and micro-sites; and integrated reporting and analytics.

The systems and methods disclosed herein allow for the ability to publish the electronic communications on both the business's main website or webpage and on the Engagement Site, provide hyperlinks between such websites or webpages and to enable the electronic communication to be shared and linked with or on one or more social media websites or webpages, such as Facebook, Twitter, LinkedIn, and other social media websites or webpages, to further leverage and increase visibility to some or all of an electronic communication sent out by the business. Embedding links back to the business's main website or webpage, Engagement Site, and/or social media sites managed by the business provides even further exposure and cross-marketing and further boosts visibility and optimization on the Internet search engine sites.

The systems and methods disclosed herein provide an improved, computerized marketing system and interface that enables a business to create and manage websites or webpages, and create, distribute, manage, and monitor its electronic marketing solutions and initiatives, such as social media monitoring and presence management, text campaigns, and other types of electronic communications from businesses to their customers and prospective customers that offer delivery of fresh, relevant written and graphic content on a consistent basis. The rich content published across a variety of channels on the Internet also contributes to improved Search Engine Optimization (SEO).

Although, some of the embodiments described above present examples with reference specifically to the industry of automobile dealership, the systems and methods may be used and implemented for any business market, sector, or industry, including, but not limited to: real estate; assisted living facilities; restaurant and hospitality; travel and tourism; education; manufacturers; service providers; retail stores; and other businesses.

The systems and methods disclosed herein may also encompass computer-readable medium having computer-executable instructions stored thereon and accessible by a dedicated computer, having a suitable processor, memory, database storage, and electronic communication capabilities to and from conventional business networks and/or the Internet. Such computer-executable instructions may be useful for performing methods or steps of such methods described herein. The systems and methods may include computer networks and other systems, components, hardware, and software, as will be appreciated by those skilled in the art, that comprise the systems described herein and that implement in whole or in part the methods or processes also described herein.

In view of the foregoing detailed description of certain embodiments, it readily should be understood by those persons skilled in the art that the systems and methods are susceptible to broad utility and application. While various aspects have been described in the context of certain aspects, features, and methodologies, many embodiments and adaptations of the systems and methods disclosed herein, as well as many variations, modifications, and equivalent arrangements and methodologies, should be apparent from or reasonably suggested by the disclosure, without departing from the substance or scope of the systems and methods disclosed herein. Although steps of various processes may be illustrated and described as being in a certain sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present disclosure.

In addition, some steps may be carried out simultaneously. Accordingly, while the systems and methods have been described herein in detail in relation to certain embodiments, it should be understood that the disclosure is only illustrative and exemplary of the systems and methods and is made for purposes of providing a full and enabling disclosure of the systems and methods. The foregoing disclosure is not intended nor is to be construed to limit the scope of the systems and methods disclosed herein or otherwise to exclude any such other embodiments, adaptations, variations, modifications and equivalent arrangements.

What is claimed is:

1. A system for increasing visibility of a businesses in Internet search engine results, comprising:
a website module accessible by a client through a user interface, the website module configured to allow the client to create an Engagement Website;
an email module accessible by the client through the user interface, the email module configured to create and send an electronic communication to a customer or prospective customer of the client, the electronic communication being published on the Engagement Website; and
a database configured to store the electronic communication.

2. The system of claim 1, wherein the Engagement Website has a domain name different from a main website of the client.

3. The system of claim 1, wherein the email module is configured to insert a hyperlink to the Engagement Website into the electronic communication.

4. The system of claim 1, further comprising a social media module accessible by the client through the user interface, the social media module configured to create and publish social media content to social media website of the client.

5. The system of claim 4, wherein the social media module is configured to monitor social media websites for comments about the client and provides suggestions to the client for responses to the comments.

6. A method for increasing visibility of a businesses in Internet search engine results, comprising:
creating, by an email module of a processor, an electronic communication from a client to a customer or prospective customer of the client;
sending, by the email module, the electronic communication to the customer or prospective customer of the client;
publishing, by the email module, the electronic communication on an Engagement Website of the client; and
caching the electronic communication published on the Engagement Website to allow Internet search engines to index the electronic communication.

7. The method of claim 6, further comprising creating, by a website module of the processor, the Engagement Website, the Engagement Website having a domain name different from a main website of the client.

8. The method of claim 6, wherein the creating step includes inserting a hyperlink to the Engagement Website into the electronic communication.

9. The method of claim 6, further comprising creating, by a social media module of the processor, social media for the client; and publishing, by the social media module, the social media content on a social media website of the client.

10. The method of claim 9, further comprising monitoring, by the social media module, social media websites for comments about the client; and providing, by the social media module, suggestions to the client for responses to the comments.
